(19) United States
(12) Patent Application Publication
(10) Pub. No.: US 2003/0220839 A1
(43) Pub. Date: Nov. 27, 2003

(54) Coupon rebate business method using portable presonal communication devices

(76) Inventor: Martin Khang Nguyen, Westminster, CA (US)

Correspondence Address: Patent Law & Venture Group, Suite K-105, 3151 Airway Ave., Costa Mesa, CA, 92626, US

(21) Appl. No.: 10/461,556

(22) Filed: Jun. 12, 2003

Related U.S. Application Data
(63) Continuation-in-part of application No. 09/931,677, filed on Aug. 15, 2001.
(63) Continuation-in-part of application No. 10/211,386, filed on Aug. 2, 2002.

(51) Int. Cl. G06F 17/60

(52) U.S. Cl. 705/14; 705/26

(57) ABSTRACT

A shopping method for receiving purchase discounts including subscribing to a discount purchase service, receiving consumer coupon discount information from the discount purchase service using at least one of a public telephone network and the Internet; purchasing an item having a coupon discount according to the coupon discount information; and receiving a discount as specified by the coupon discount information.

### RELATED PATENT APPLICATIONS

The present application claims priority, as a continuation in part, of prior filed applications that are co-pending, with Ser. Nos. 09/931677 having an official filing date of Aug. 8, 2001, and 10211386 having an official filing date of, Aug. 02, 2002.

### BACKGROUND OF THE INVENTION

### INCORPORATION BY REFERENCE

Applicant(s) hereby incorporate herein by reference, any and all U.S. patents, U.S. patent applications, and other documents and printed matter cited or referred to in this application.

1. Field of the Invention

This invention relates generally to consumer discount purchase methods and more particularly to a business method for obtaining consumer discounts without presenting paper discount coupons.

2. Description of Related Art

The following art defines the present state of this field:

Valencia et al., U.S. Pat. No. 5,380,991 describes a system and method of allowing a shopper to obtain the benefit of reduced prices for certain items without the necessity of redeeming paper coupons. The system employs an integrated circuit (IC) smart card containing an erasable memory therein. This memory would contain information relating to a discount coupon amount, as well as information relating to particular products which have been purchased. This card would be inserted into a reader/writer terminal provided at a retailer's checkout counter. Items which are purchased are scanned and compared with items to be discounted as well as the information provided by the customer IC smart card. After the cashier has totaled the customer's purchases, the information contained in the IC smart card would be altered accordingly.

Powell, U.S. Pat. No. 5,727,153 describes a system for creating, dispensing, and redeeming electronic discount coupons in a store. The system includes a “smart card”, product stations adjacent to selected products in the store, and a checkout station in the checkout area. To create an electronic coupon, the customer inserts the card into the product station adjacent to an product the customer wishes to purchase, and the product station then writes an electronic coupon onto the card. The customer thus shops throughout the store collecting electronic coupons for products of interest. Upon completion of shopping, the customer redeems the electronic coupons at the checkout area, by inserting the card into the checkout station. During checkout, when UPC data matches data stored on the card, the customer is credited with the value of the corresponding coupon. Periodically, the electronic coupon data is transferred to a remote clearing house.

Stich, et al., U.S. Pat. No. 5,760,381 describes debit cards, such as long distance telephone cards, being attractively packaged and even readily mounted for point of purchase display, in such a manner that the card is inactive until activated at the point of purchase. The card may be activated at the point of purchase without the necessity of in any way opening up the attractive packaging, or moving any portion of the packaging out of the way, and by merely “swiping” the card while still mounted in the package through a conventional card reader. The card is mounted between first and second panels of primarily cellulose material including an area significantly greater than that of the card, with the card magnetic strip completely exposed (that is uncovered by the panels or any other packaging material). The majority of the card is typically sandwiched between the first and second panels and is, removably held to the panels, for example by hold melt adhesive, and the panels are affixed to each other.

Baron et al., U.S. Pat. No. 5,809,481 describes a method and system for advertising that provides advertisers with a marketing database listing contact information for all potential consumers who received a promotional item from that advertiser and decided to retain the promotional item for future use. The promotional item is a tag bearing an advertisement, a contact identifier and a unique tag identifier. After receiving the tag from an advertiser, each recipient is instructed to attach the tag to a personal property item and to register the item with a processing facility that, with the use of an information storage and retrieval system, will create a master database comprising each recipient's contact information and tag identifier. The master database can be used to arrange for the return of a lost personal property item bearing a registered tag. The master database can also be sorted and contact information can be extracted therefrom to generate a marketing database for transmittal to advertisers.

Fajkowski, U.S. Pat. No. 5,905,246 describes a system for the electronic management and redemption of coupons. The system includes an integrated coupon card comprising a microprocessor, a random access memory, a scanner, and a communications port. The coupon card is capable of scanning coupon bar codes from paper coupons and receiving redemption requirement data from a periphery device. The coupon card will allow bar codes and redemption requirement data to be transferred to a periphery device and will store what bar codes were redeemed because they corresponded to purchase data received from a cash register memory. The system further includes one or more periphery devices having a microprocessor, a first communications port for communicating with said coupon card, and a second communications port for communicating with a cash register. The periphery devices receive purchase data from a cash register memory and compare purchase data to coupon bar codes received from a coupon card in order to determine which coupons are redeemable. The system also includes a server computer which will be connected to the periphery devices. The server computer will collect redeemed coupon information from the periphery devices and also provide the periphery devices with information such redemption requirement data or coupons which may be loaded onto a coupon card. A clearing house will collect coupon redemption information from all servers in the system to create redemption reports. The clearing house allows redemption requirement data and other information to be transferred through the servers to individual periphery devices and/or coupon cards.

Fiala, et al., U.S. Pat. No. 5,918,909 describes a method of activating a metered account that is associated with a personal identification number, where the personal identification number is affixed to a card and the metered account is activated at the time of sale of the card, and an apparatus comprising a package adapted for holding the card so that the method of the present invention can be practiced. The card includes an exposed data-encoded strip and the card preferably has a personal identification number thereon. The package includes a first panel and a retainer that secures the card to the first panel so that, when the card is secured to the panel, at least a portion of the data-encoded strip is exposed and laterally displaced remote from the panel. The data-encoded strip is encoded with a control number that is associated with the metered account. When the card is purchased, the control number is read from the data-encoded strip while the card is secured to the first panel, and the metered account is activated.

Christensen, U.S. Pat. No. 6,035,280 describes a method and apparatus for distributing, generating, and redeeming discount Virtual Coupons.TM., rebate or gift certificates or the like which may be used on conjunction with a frequency card program or the like. Virtual Coupons.TM. may be distributed electronically, for example, in the form of a diskette or CD-ROM software. Software on the diskette or CD-ROM may prompt a consumer to call a 1-800 number for a validation number or code. During the phone call, telemarketing personnel may request consumer demographic and or identification information which may be entered into a centralized database. Once the software is validated, a consumer may print out a list selected Virtual Coupons.TM. displayed on a Graphical User Interface (GUI). When a product is purchased, the UPC code of the product may be compared electronically with a list of Virtual Coupons.TM. authorized for a particular consumer. An appropriate coupon discount may then be applied and the Virtual Coupon.TM. may be considered “redeemed”. Once redeemed, consumer ID information and Virtual Coupon.TM. information may be retrieved electronically and used to update a central database. Accurate data may then be produced illustrating which consumers or groups of consumers are redeeming which Virtual Coupons.TM.. Such data may be used for marketing purposes or to generated further diskettes for distribution targeting specific consumers or groups of consumers with specific classes of Virtual Coupon.TM. offerings. The use of Virtual Coupons.TM. eliminates or reduces fraud, and allows a frequency card discount to be applied only a limited number of times.

Fertig, U.S. Pat. No. 6,050,493 describes a pre-paid card for sending a gift such as flowers that is sized to fit inside a wallet, having a front face with photographs or drawings with a plurality of pre-selected gift items and back face with warranty and instructional information, as well as a telephone access number and a PIN number which is unique to the card. A plurality of pre-selected items depicted on the front face of the card will each have a corresponding identifier number or code, so that the card user can easily select a gift item to be ordered.

Bowie, U.S. Pat. No. 6,195,644 describes a method whereby credit card companies can program their computers to record and award Bonus Program Credits offered by airlines, hotels, rental car companies, etc. and relieve the latter of the burden of maintaining such records. This Abstract is not to be construed as a complete description of the invention or to limit the scope of the disclosure of the invention or of the claims.

Powell, U.S. Pat. No. 6,243,687 describes a system for dispensing and redeeming electronic discount coupons in a store. A card-dispensing kiosk collects information from a customer and subsequently issues a “smart card” for storing electronic coupons. Upon completion of shopping, the customer redeems the electronic coupons at the checkout area, by inserting the card into the checkout station. During checkout, when UPC product data corresponds to coupons stored on the card, the customer is credited with the value of the corresponding coupon.

The prior art teaches the use of coupons, paperless coupons, electronic coupons and such, but does not teach a method of using an electronic portable device in place of paper coupons and which may be used at the point of purchase. The present invention fulfills these needs and provides further related advantages as described in the following summary.

### SUMMARY OF THE INVENTION

The present invention teaches certain benefits in construction and use which give rise to the objectives described below.

One embodiment of a shopping method for receiving purchase discounts comprises the steps of subscribing to a discount purchase service; receiving notice of purchase discounts on special consumer items, from the discount purchase service; purchasing the special consumer items from vendors and requesting discount rebates from the purchase service. In an alternate embodiment, the discount is made at point of purchase by swiping a smart card having purchaser identification so that the vendor is able to prove that a purchase took place. In place of the smart card, a portable communication device is able to send wireless information to a receiver at the point of purchase. The consumer may receive the purchase discount at point of purchase, from the purchase service as a rebate or from the manufacturer as a rebate.

A primary objective of the present invention is to provide a method that provides advantages in shopping that is not taught by the prior art.

Another objective is to provide such an invention capable of enabling consumer purchase discounts without using paper discount coupons.

A further objective is to provide such an invention capable of transmitting and reviewing data using wireless portable communication devices.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawing illustrate the present invention. In such drawing:

FIG. 1 is a block diagram illustrating the relationship between consumers, vendors, manufacturers and a discount service of the invention method;

FIG. 2 is a perspective view illustrating the use of a portable communication device in the invention method;

FIG. 3A is a plan view of a display of the portable communications device showing a comparison of discounts available for different brands of a commodity;

FIG. 3B is a plan view of the display showing a comparison of product prices available from various vendors; and

FIG. 3C is a plan view of the display showing a discount coupon.

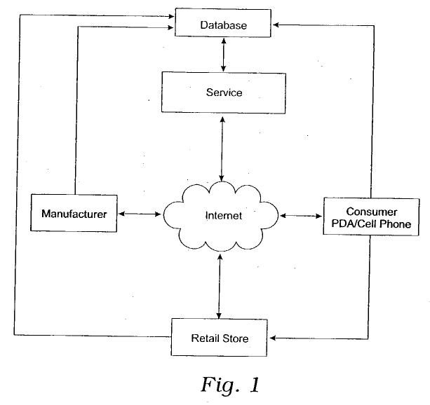

### DETAILED DESCRIPTION OF THE INVENTION

The above described drawing figures illustrate the invention in at least one of its preferred embodiments, which is further defined in detail in the following description.

The present invention is a shopping method for receiving purchase discounts. In this method consumers subscribe (subscribers) to a discount purchase service that is made widely available for implementing the present method. The subscribers are made aware of discounts that are available for certain items for sale, such as products, services and privileges. Using this knowledge, the subscribers make purchases and receive discounts or rebates relative to the current price of the items.

Consumer discounts are issued broadly as publicly available consumer discount coupons for items being offered for sale. Coupons are issued in magazines, newspapers and are mailed to consumers in quantities (packs). Almost all consumer products and services may be purchased using such coupons and grocery coupons are especially common and they are widely known, used and demanded by thrifty consumers. Such coupons may be used for the purchase of products and services and, in this specification and claims set, the word “coupon” is used to mean published or printed items or materials that may come into the hands of consumers and which are generally honored by vendors when a consumer presents such a coupon during a purchase. Alternately, the coupon may be later redeemed for a rebate against the purchase price.

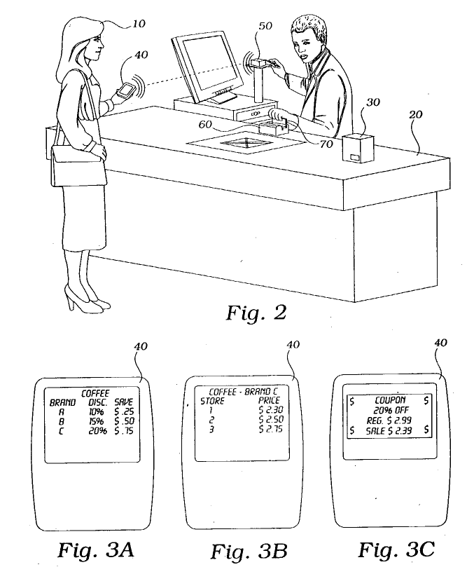

Such coupons generally identify the nature of an item for sale such as its identity, size, type, etc., as for instance the name and model number of a hardware item on sale, a car wash service, or the privilege of a seat at a performance on a given date. The coupon also generally identifies the non-discounted price of the product or service, and a discount amount or percent being made available to the bearer, as well as other information such as name and location of vendors that will honor such coupons, etc. Still other information is generally included on the coupon, such as the issuer's identity, date of expiration, etc. The method of the present invention includes the step of transmitting this information to a vendor at a point of sale. With paper coupons, this step is accomplished by handing-over the coupon to the vendor. The vendor accommodates the reduced price by treating it as the actual retail price. In some instances the coupon is returned to the manufacturer for a rebate from the manufacturer. In the present invention the manufacturer's rebate may be obtained by the vendor or by the consumer-subscriber. In the former case, the vendor identified the number of items sold and requests rebate. In the latter case, the consumer may obtain a discount at point of purchase, as defined above, or may request a rebate from the discount purchase service or directly from the manufacturer. The rebates are obtained through a recognition step using either the wireless communication device of the consumer, or an identification or smart card. This communication preferably includes a pictorial representation of a printed coupon showing the item price and discount thereon. This informs shoppers that certain items have discounting through coupons. Such pictorial representations may be displayed on the wireless communication device so that the consumer sees the discount coupon in its customary form as it might appear as a printed paper coupon (see FIG. 3C). Alternately, the information may be placed in a smart (memory on board) card via Internet communications to a card reader/writer. The consumer may review a large number of such coupons and upon selecting an item for purchase, the consumer may purchases an item from a vendor. At the point of purchase, the consumer transmits a service identification code, item specification, price and discount information which corresponds to the selected coupon, and may be done via wireless or wire interconnection with a high degree of automation. Also, as shown in FIG. 2 a smart type card may be scanned to pick-up this information.

At this time, the consumer receives a discounted price for the purchased item at the point of purchase. The follow-up to this approach includes the step of transmitting the discounted price information from the vendor to the discount purchase service, whereby, the service provides a discount rebate to the vendor. Of course, with a large volume of purchases, the amount of funds transfer between the service and any specific vendor may be quite large.

Following the above step, the service seeks and obtains a rebate of the discount from the manufacturer or provider of the item purchased. Clearly, it is the manufacturer/provider that has the initial interest in discounting listed prices in order to improve sales volume or other business variables. Thus, the ultimate source of rebates on such discounted items is the originator of the purchased item.

In the present invention method, the wireless communication device may be a cell phone, pager, PDA or any other personal portable device with the capability of communicating with the discount purchase service. Such communication may be via the Internet or the public telephone network or other communications network, and uses any appropriate communications protocol well known to those of skill in the art. In this specification we use the term “wave energy communications transfer” to mean any energetic communications method including radio frequency, microwave, light, laser beam, ultra-sonic sound, audible sound, infrared light beam, and other known methods such as digital data transfer via the Internet or other network systems well known in the art. At check-out shoppers may use their identification cards, loyalty cards, credit cards, etc. instead of a portable communications device.

In FIG. 2 is shown a preferred method of the present invention, wherein the consumer 10 is shown at a check-out counter 20 where her purchase 30 has just been “rung-up.” She uses her personal communication device 40 to send discount coupon information stored in the device 40 to a reader 50 at the check-out counter 20. The vendor, typically a retail establishment, is then able to take the discount into account in determining the selling price of the purchase 30. In an alternate approach, the consumer communicates the nature of her purchases along with a proof of purchase to the discount purchase service and thereafter receives a rebate equal to the discount stated on the coupon, or alternately, the difference between the actual price paid and the price advertised on the coupon. Such communication between consumer and the service may be by wireless using the public phone system or may be via the Internet using a home computer with a card reader/writer, for instance, wherein a proof of purchase, such as a receipt, may be scanned into a file that is then transferred to the service. As shown in FIG. 2, a smart card 70 may be scanned instead of using a wireless device. The smart card may be a credit card sized unit with a memory on board or it may be a loyalty type card or a common credit card.

In the present method, the discount purchase service engages in contractual relationships with both manufacturers/providers as well as retailers and other points of sale. Such relationships provide benefit to the manufacturer in that the service enhances and advantageously channels consumer business to participating manufacturers, leaving those that do not participate at a disadvantage. Such relationships also provide benefit to those retailers and other points of sale that participate. The benefit to manufacturer and retailer come into existence due to the improved commercial awareness of specified products to consumers and especially of the consumer benefits available. The benefits to manufacturer and retailer are reflected in a service fee that one or both may pay to the service, and such a fee is preferably calculated as a percent of sales volume through the present method.

Consumers benefit from the present invention method in that it is highly convenient for the consumer to view the available items for sale on the personal portable communication device. Such commercial presentation has the advantage of attracting the attention of the consumer in preference to television-radio and printed commercial copy because it is carried on the person of the consumer and is presented in a device that is used by the consumer frequently. Those that are interested in capturing the preferential attention of the consumer may indeed provide offers to the consumer as discounts in the cost of use of the personal communication device. This is similar to the free or low cost of use of certain Internet services when the user is willing to accept a certain amount of commercial messaging.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A shopping method for receiving purchase discounts comprising the steps of: subscribing to a discount purchase service; receiving consumer coupon discount information from the discount purchase service using at least one of a public telephone network and the Internet; purchasing an item having a coupon discount according to the coupon discount information; and receiving a discount as specified by the coupon discount information.

2. The method of claim 1 wherein the discount is received during the purchase, at a point of purchase, as a reduction in purchase price.

3. The method of claim 1 wherein the discount is received after the purchase, as a rebate, from the discount purchase service, the discount purchase service receiving a refund of an amount equal to the rebate plus a service fee from a manufacturer of the item purchased.

4. The method of claim 1 wherein the discount is received after the purchase, as a rebate, from the manufacturer.

5. The method of claim 1 wherein the consumer coupon discount information is received in a wireless communications device from the discount purchase service and further comprising wireless communication of the coupon discount information and purchaser information at a point of purchase to enable the coupon discount.

6. The method of claim 5 wherein the wireless communication device is one of a cell phone, pager and PDA.

7. The method of claim 5 wherein the consumer coupon discount information appears as a facsimile of a printed coupon on a display of the wireless communication device.

8. The method of claim 1 wherein the consumer coupon discount information is received in a smart card using a card reader/writer, from the discount purchase service and further comprising card-swipe communication of the coupon discount information and purchaser information at a point of purchase to enable the coupon discount.
